(19) United States
(12) Patent Application Publication
(10) Pub. No.: US 2026/0168422 A1
(43) Pub. Date: Jun. 18, 2026

(54) METHOD AND DEVICE FOR REGENERATING EXHAUST PARTICULATE FILTER IN V-TYPE INTERNAL COMBUSTION ENGINE FOR VEHICLE

(71) Applicant: NISSAN MOTOR CO., LTD., Yokohama-shi (JP)

(72) Inventors: Isamu UEHARA, Kanagawa (JP); Hideyuki SUZUKI, Kanagawa (JP); Akikazu SAKAI, Kanagawa (JP)

(73) Assignee: NISSAN MOTOR CO., LTD., Yokohama-shi (JP)

(21) Appl. No.: 19/422,051

(22) Filed: Dec. 16, 2025

(30) Foreign Application Priority Data
Dec. 17, 2024 (JP) 2024-220465

(51) Int. Cl. F01N 9/00; F01N 13/00; F02B 75/22; F02P 5/15

(52) U.S. Cl. CPC F01N 9/002; F01N 13/011; F02B 75/22; F02P 5/1504; F01N 2900/1606

(57) ABSTRACT

In a V-type internal combustion engine, the soot accumulation amount in each exhaust particulate filter 7 and 8 of banks is estimated. When the soot accumulation amount in the exhaust particulate filter 7 with a higher soot accumulation amount exceeds a threshold SL, regeneration process for both the banks starts. The regeneration process is performed by simultaneously retarding the ignition timing for both the banks and increasing the rotational speed through shifting of the automatic transmission. The regeneration process is terminated when the soot accumulation mount in the exhaust particulate filter 8, which has a lower soot accumulation amount, reaches a lower limit soot amount Min.

### BACKGROUND

The present invention relates to a method and device for regenerating an exhaust particulate filter in a V-type internal combustion engine for vehicles, which is a spark-ignition-type engine provided with a pair of banks, and an exhaust particulate filter provided in the exhaust passage of each of the banks.

In recent years, with increasing demands for exhaust purification performance in automobiles, even in spark-ignition internal combustion engines (so-called gasoline engines), an exhaust particulate filter tends to be provided in an exhaust system to remove soot from the exhaust. Then, in a V-type internal combustion engine having a pair of left and right banks, an exhaust particulate filter may be disposed in the exhaust passage of each of the independent banks.

Excessive soot accumulation in the exhaust particulate filter causes a so-called clogged state, leading to a decrease in output. Therefore, a regeneration process is necessary at an appropriate time to remove the soot by forcibly increasing exhaust temperature.

A Japanese Patent Application Publication No. 2008-111392 (hereinafter is simply referred to as a “patent document 1”) relates to a regeneration process of an exhaust particulate filter for a diesel engine, not a spark-ignition internal combustion engine, and discloses a technique for regenerating only the exhaust particulate filter of one of the banks of a V-type internal combustion engine by increasing exhaust temperature through fuel injection timing retard or post-injection in the cylinders of the bank when the amount of the soot accumulation in the exhaust particulate filter of the bank exceeds a threshold value.

However, although, in spark-ignition internal combustion engines, the ignition timing retard can increase exhaust temperature, with this alone, rapid completion of exhaust particulate filter regeneration is not always ensured. Furthermore, when performing ignition timing retard on only one bank, there is a risk that output becomes imbalance between the left and right banks.

### SUMMARY

The present invention is a method for regenerating exhaust particulate filters in a V-type internal combustion engine for a vehicle, wherein the V-type internal combustion engine is a spark-ignition-type engine, has a pair of banks and the exhaust particulate filters provided in respective exhaust passages of the pair of banks, and is connected with an automatic transmission, the method comprising: estimating a soot accumulation amount of each of the exhaust particulate filters of a corresponding one of the banks; and simultaneously starting regeneration process for the exhaust particulate filters of both the respective banks based on the soot accumulation amount of at least one of the exhaust particulate filters of the banks, wherein the regeneration process is performed by retarding ignition timing of both the banks and increasing an engine rotational speed of the internal combustion engine by changing a transmission ratio of the automatic transmission.

By increasing the rotation speed of the internal combustion engine by changing the transmission ratio of the automatic transmission and performing ignition timing retard for both the banks, exhaust energy increases, allowing the exhaust particulate filter to regenerate rapidly. By combining this temperature increase method such as a change in transmission ratio in this way, a required ignition timing retard amount becomes relatively small and the occurrence of output imbalance between the left and right banks is suppressed. Furthermore, since the exhaust temperature increase by the transmission ratio change inevitably occurs in both the banks, as compared to alternately regenerating the exhaust particulate filters of the left and right banks, the fuel economy deterioration is less, in the end.

According to the present invention, in a V-type internal combustion engine, it is possible to suppress the deterioration in fuel economy associated with the regeneration process of the exhaust particulate filters, avoid output imbalance, and efficiently regenerate the exhaust particulate filters.

### BRIEF DESCRIPTION OF THE DRAWINGS

FIG. 1 is a schematic diagram of a V-type internal combustion engine for a vehicle in one embodiment.

FIG. 2 is a flowchart showing the basic processing flow of a regeneration process in one embodiment.

FIG. 3 is a time chart showing the operation of a first embodiment.

FIG. 4 is a time chart showing the operation of a second embodiment.

FIG. 5 is a characteristic diagram showing a relationship between soot accumulation amount and collection efficiency in an exhaust particulate filter.

### DETAILED DESCRIPTION

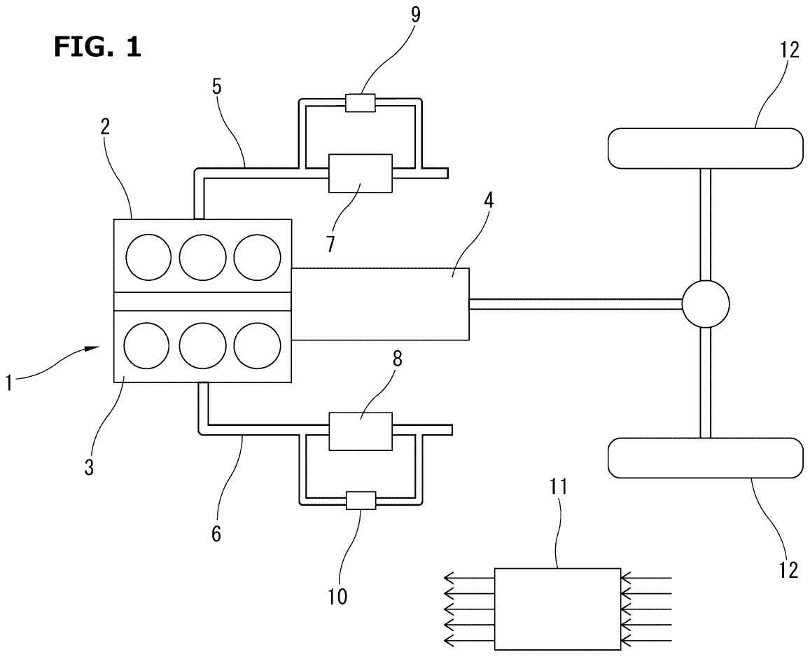

In the following, one embodiment of the present invention will be explained with reference to the drawings. FIG. 1 shows a V-type internal combustion engine 1 in an embodiment that is mounted on a vehicle. The internal combustion engine 1 is a spark-ignition internal combustion engine, commonly known as a gasoline engine, and in one embodiment, it is configured as a V-type 6-cylinder engine having a first bank 2 and a second bank 3. Furthermore, this V-type internal combustion engine 1 is mounted in the vehicle in a so-called longitudinal layout and drives rear wheels 12 via an automatic transmission 4 connected to its rear end.

The automatic transmission 4 is a stepped automatic transmission combining, for example, a torque converter and a stepped automatic transmission mechanism. In the stepped automatic transmission mechanism, as is well known, shifting is basically performed along a shift line using vehicle speed and accelerator pedal opening degree as parameters. In addition, the automatic transmission 4 may also be a continuously variable transmission (CVT) using, for example, a belt-type CVT mechanism.

The first bank 2 and the second bank 3 have exhaust passages 5 and 6, respectively, and exhaust particulate filters 7 and 8 (so-called GPF) for removing soot from the exhaust are provided in the exhaust passage 5 and 6, respectively. The exhaust particulate filters 7 and 8 consist of wall-flow type filters using, for example, a sealed-type monolithic ceramic body made of a material such as cordierite. The configuration of each of the exhaust particulate filters 7 and 8 in which coating is performed to the inner wall surfaces of fine passages (cells) with a catalyst metal to function as a three-way catalyst may be used. The exhaust particulate filters 7 and 8 may be of any type, such as metal filters.

The exhaust passages 5 and 6 respectively include differential pressure sensors 9 and 10 that detect the pressure difference across the exhaust particulate filters 7 and 8 to detect pressure loss correlated with the soot accumulation amount in the exhaust particulate filters 7 and 8. Alternatively, pressure sensors may be provided on the respective inlet and outlet sides of each of the exhaust particulate filters 7 and 8 instead of the differential pressure sensors 9 and 10.

The detection signals from the above differential pressure sensors 9 and 10 are input to an engine controller 11 that performs various controls of the internal combustion engine 1. Although not shown, the engine controller 11 receives detection signals from various sensors directly or via another controller, such as a crank angle sensor for detecting engine rotation speed, an air flow meter for detecting intake air amount corresponding to load, a water temperature sensor for detecting cooling water temperature, an accelerator pedal position sensor for detecting the opening amount (depression amount) of the accelerator pedal operated by the driver, an air-fuel ratio sensor for detecting exhaust air-fuel ratio, and a vehicle speed sensor for detecting vehicle speed. Based on these detection signals, the engine controller 11 optimally controls the fuel injection amount and injection timing by fuel injection valves, the ignition timing by spark plugs, the throttle valve opening amount, and the like. Furthermore, the engine controller 11 can provide shift instructions related to the regeneration process described later to the automatic transmission 4 via an AT controller (not shown).

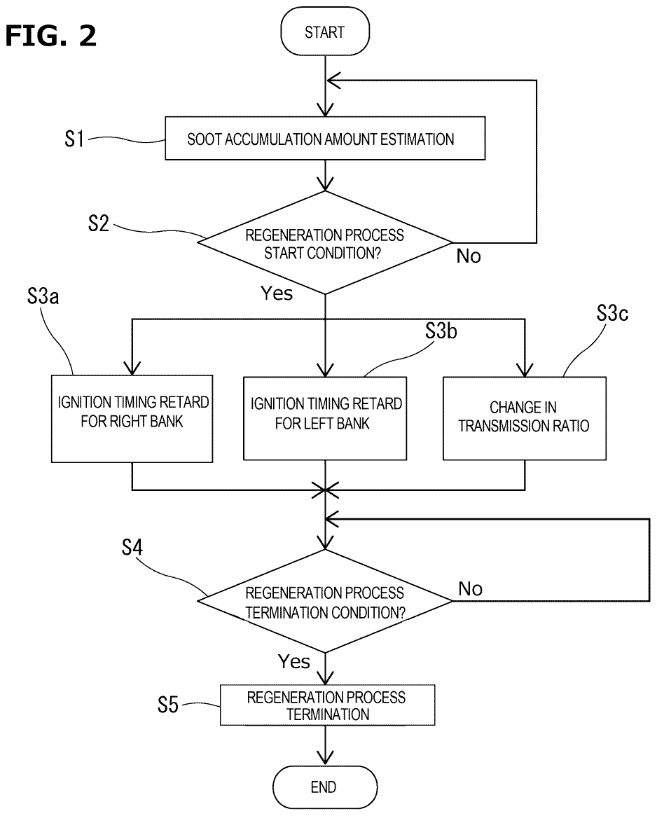

Next, FIG. 2 is a flowchart showing the basic processing flow of the regeneration process in one embodiment. First, in a step 1, the soot accumulation amount in each of the exhaust particulate filters 7 and 8 is estimated. The soot accumulation amount is estimated based on, for example, the pressure difference across the exhaust particulate filters 7 and 8 detected by the differential pressure sensors 9 and 10 described above, and the flow rate of gas passing through the exhaust particulate filters 7 and 8. The gas flow rate is a known value for each operating point (combination of rotation speed and torque) of the internal combustion engine 1 at that time. In addition, in the present invention, the estimation of the soot accumulation amount may be performed by any other known method.

Next, in a step 2, based on the soot accumulation amount in each of the exhaust particulate filters 7 and 8, it is determined whether the start condition for the regeneration process is satisfied. When it is determined that the start condition is not satisfied, the process is returned to the step 1, and the estimation of the soot accumulation amount is repeated.

When it is determined in the step 2 that the start condition for the regeneration process is satisfied, as the regeneration process, the processes of steps 3a, 3b, and 3c are performed in parallel. In the step 3a, ignition timing retard of the first bank 2 is performed in which the ignition timing of the first bank 2 is shifted from the base ignition timing toward a retarded angle. Similarly, in the step 3b, ignition timing retard of the second bank 3 is performed in which the ignition timing of the second bank 3 is shifted from the base ignition timing toward a retarded angle. The retard amount for the ignition timing of each of the two banks 2 and 3 can basically be the same. In the step 3c, the automatic transmission 4 is downshifted to a lower stage. In addition, in case of a continuously variable transmission, an appropriate change in transmission ratio is performed.

By the ignition timing retard, the exhaust temperature of each of the banks 2 and 3 increases. Furthermore, by the change in transmission ratio accompanying the downshift, the rotation speed of the internal combustion engine 1 increases, resulting in a larger amount of exhaust energy being supplied to the exhaust particulate filters 7 and 8 of the corresponding banks 2 and 3. With this, the soot in the exhaust particulate filters 7 and 8 is oxidized or burnt, thereby being removed. In other words, regeneration of the exhaust particulate filters 7 and 8 is performed.

In a step 4, based on the soot accumulation amount in the exhaust particulate filters 7 and 8, which decreases during the regeneration process, it is determined whether the regeneration process termination condition is satisfied. When it is determined that the regeneration process termination condition is not satisfied, the regeneration process continues. When the termination condition for the regeneration process is determined to be satisfied in the step 4, the process proceeds to a step 5 and the regeneration process is terminated. Specifically, the forced ignition timing retard is ended, and the transmission is returned to a stage with normal characteristics.

In this way, in the above embodiment, the regeneration process for the exhaust particulate filters 7 and 8 of both the banks 2 and 3 is always performed simultaneously. Furthermore, since, in addition to the exhaust temperature increase by the ignition timing retard in each of the banks 2 and 3, an increase in exhaust energy is performed by changing the transmission ratio, required retard amount for the ignition timing retard is relatively small, and combustion instability caused by the ignition timing retard is suppressed. Moreover, since the ignition timing retard is performed in both the banks 2 and 3, no output imbalance occurs between the left and right banks 2 and 3.

Furthermore, since the exhaust temperature increase by the change in the transmission ratio inevitably occurs in both the banks 2 and 3, fuel economy deterioration is less compared to when the exhaust particulate filters 7 and 8 for the left and right banks 2 and 3 are regenerated alternately. That is, when performing the regeneration process by combining a change in transmission ratio affecting both the banks 2 and 3 with the ignition timing retard, the fuel economy deterioration caused by the increase in rotation speed during the regeneration of only one of the exhaust particulate filters 7 and 8 is equivalent to that during simultaneous regeneration of both the banks 2 and 3. Therefore, simultaneously regenerating both the banks 2 and 3 to reduce the total number of regeneration cycles is advantageous for fuel economy.

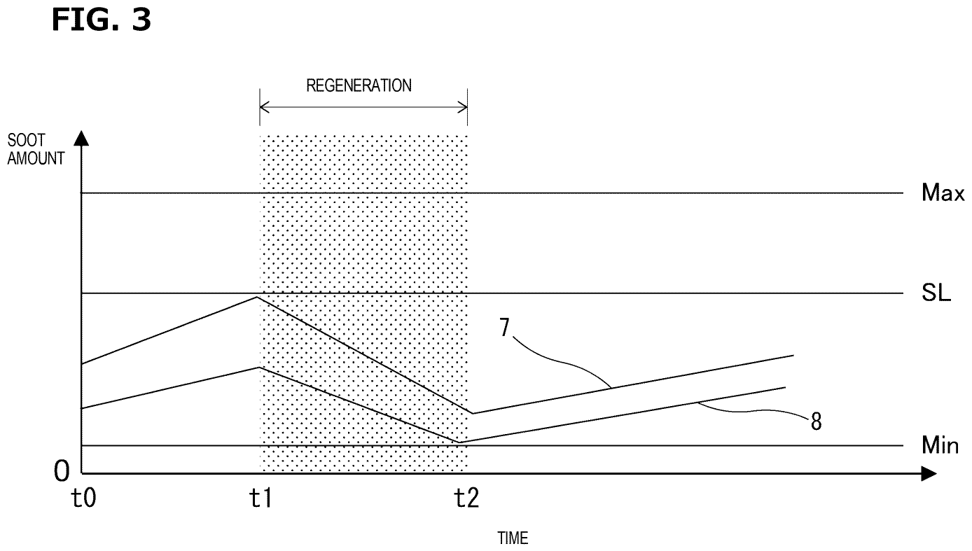

Next, FIG. 3 is a time chart showing a more specific operation of the first embodiment. In this first embodiment, as a start condition for the regeneration process, when the soot accumulation amounts of the two exhaust particulate filters 7 and 8 are compared with each other, and the soot accumulation amount of the exhaust particulate filter, which has a higher soot accumulation amount, exceeds a predetermined threshold value SL, the start condition for the regeneration is satisfied. Furthermore, as the termination condition for the regeneration process after the starting of the regeneration process, when the soot accumulation amounts of the two exhaust particulate filters 7 and 8 are compared with each other, and the soot accumulation amount of the exhaust particulate filter, which has a lower soot accumulation amount, decreases to a predetermined lower limit soot amount Min, the termination condition is satisfied.

In the example of FIG. 3, the soot accumulation amount in each of the exhaust particulate filters 7 and 8 increases from time to. For example, the soot accumulation amount in the exhaust particulate filter 7 is greater than that in the exhaust particulate filter 8, and at time t1, the soot accumulation amount in the exhaust particulate filter 7 exceeds the threshold value SL. Consequently, at time t1, the regeneration process starts. That is, ignition timing retard is executed for both the banks 2 and 3, and the automatic transmission 4 is downshifted to a lower stage, and then rotation speed increases. By this regeneration process, the soot accumulation amount in each of both the exhaust particulate filters 7 and 8 is gradually reduced. In addition, the above threshold value SL is set at a level lower than a clogging level Max, which represents the soot accumulation amount considered clogging of the exhaust particulate filters 7 and 8.

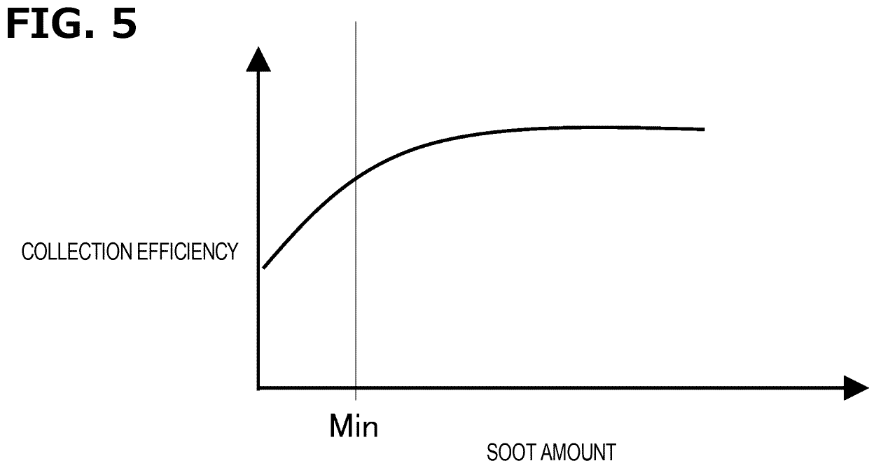

At time t2, the soot accumulation amount in the exhaust particulate filter 8, which has a lower soot accumulation amount, decreases to the lower limit soot amount Min, and the regeneration process is terminated. Here, the lower limit soot amount Min is the soot accumulation level set to ensure the collection efficiency of an exhaust particulate filter. As shown in FIG. 5, which illustrates the relationship between soot accumulation amount and collection efficiency in an exhaust particulate filter, collection efficiency decreases when the soot accumulated in an exhaust particulate filter is extremely low. That is, although a high soot accumulation amount causes greater pressure loss, from the perspective of collection efficiency that suppresses soot discharge, a certain amount of soot accumulation is desirable. Therefore, the lower limit soot amount Min is set at a level where the collection efficiency does not become excessively low, as shown in FIG. 5.

According to the first embodiment, since the regeneration process is performed when the soot accumulation amount in one of the exhaust particulate filters 7 and 8, which has a higher soot accumulation amount, exceeds the threshold value SL, excessive soot accumulation in either of the two exhaust particulate filters 7 and 8 is suppressed. Furthermore, since the regeneration process is terminated when the soot accumulation amount of the exhaust particulate filter 7 or 8, which has a lower soot accumulation amount, reaches the lower limit soot amount Min, both the exhaust particulate filters 7 and 8 are maintained at or above the lower limit soot amount Min, thereby suppressing an excessive decrease in collection efficiency.

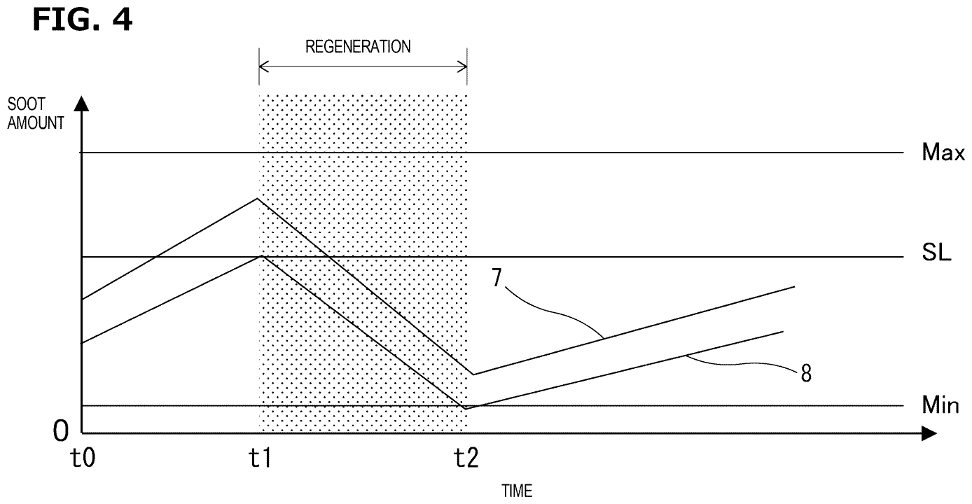

Next, FIG. 4 is a time chart showing the operation of a second embodiment. In the second embodiment, as a start condition for the regeneration process, when the soot accumulation amounts of the two exhaust particulate filters 7 and 8 are compared with each other, and the soot accumulation amount of the exhaust particulate filter, which has a lower soot accumulation amount, exceeds the predetermined threshold value SL, the start condition is satisfied. Furthermore, as a termination condition for the regeneration process after starting the regeneration process, similar to the first embodiment, when the soot accumulation amounts of the two exhaust particulate filters 7 and 8 are compared with each other, and the soot accumulation amount of the exhaust particulate filter, which has a lower soot accumulation amount, reaches the predetermined lower limit soot amount Min, the termination condition is satisfied.

In the example of FIG. 4, the soot accumulation amount in each of the exhaust particulate filters 7 and 8 increases from time to. For example, the soot accumulation amount in the exhaust particulate filter 8 is lower than that in the exhaust particulate filter 7, and at time t1, the soot accumulation amount in the exhaust particulate filter 8 exceeds a threshold value SL. Consequently, at time t1, the regeneration process starts. Specifically, ignition timing retard is executed for both the banks 2 and 3, and the automatic transmission 4 is downshifted to a lower stage, and then rotation speed increases. By this regeneration process, the soot accumulation amount in both the exhaust particulate filters 7 and 8 is gradually reduced.

Here, the threshold value SL in the second embodiment may be set at the same level as the threshold value SL in the first embodiment, or it may be set at a level slightly lower than the threshold SL in the first embodiment to provide a larger margin with respect to the clogging level Max of the soot accumulation amount that can be considered clogging of the exhaust particulate filters 7 and 8.

At time t2, the soot accumulation amount in the exhaust particulate filter 8, which has a lower soot accumulation amount, decreases to the lower limit soot amount Min. Consequently, the regeneration process is terminated.

According to the second embodiment, the regeneration process is not performed until the soot accumulation amount of the exhaust particulate filter 7 or 8 with the a lower soot accumulation amount exceeds the threshold value SL, and the regeneration process at the stage where the soot accumulation amount of one of the exhaust particulate filters 7 and 8 is low is suppressed. That is, depending on the setting of the threshold value SL, the frequency of the regeneration process is fundamentally reduced compared to the first embodiment, thereby suppressing a deterioration in fuel economy.

As the above, one embodiment of the present invention has been explained in detail. However, the present invention is not limited to the above embodiments and various changes might be made to the embodiments without departing from the scope and spirit of the present invention. The present invention includes equivalents thereof. For example, in the above embodiments, the regeneration process is terminated when the soot accumulation amount of the exhaust particulate filter 7 or 8 with the lower soot accumulation amount reaches the lower limit soot amount Min, as a regeneration process termination condition. However, the regeneration process may be continued until the soot accumulation amount of the exhaust particulate filter 7 or 8 with a higher soot accumulation amount reaches the lower limit soot amount Min. Alternatively, in case of exhaust particulate filters that can maintain collection efficiency even with low soot accumulation amount, the regeneration process may be continued until the soot accumulation amount reaches zero. Furthermore, the passage of a predetermined time may also be used as a regeneration process termination condition.

In addition, the regeneration process start condition is not limited to the above embodiments. For example, it is also possible to start the regeneration process when the difference in soot accumulation amounts between the two exhaust particulate filters 7 and 8 increases beyond a certain threshold level.

The entire contents of Japanese Patent Application 2024-220465 filed Dec. 17, 2024 is incorporated herein by reference.

1. A method for regenerating exhaust particulate filters in a V-type internal combustion engine for a vehicle, wherein the V-type internal combustion engine is a spark-ignition-type engine, has a pair of banks and the exhaust particulate filters provided in respective exhaust passages of the pair of banks, and is connected with an automatic transmission, the method comprising:
estimating a soot accumulation amount of each of the exhaust particulate filters of a corresponding one of the banks; and
simultaneously starting regeneration process for the exhaust particulate filters of both the respective banks based on the soot accumulation amount of at least one of the exhaust particulate filters of the banks,
wherein the regeneration process is performed by retarding ignition timing of both the banks and increasing an engine rotational speed of the internal combustion engine by changing a transmission ratio of the automatic transmission.

2. The method for regenerating the exhaust particulate filters in the V-type internal combustion engine for the vehicle according to claim 1,
wherein the regeneration process starts when the soot accumulation amount of one of the two exhaust particulate filters, which has a higher soot accumulation amount, exceeds a predetermined threshold value.

3. The method for regenerating the exhaust particulate filters in the V-type internal combustion engine for the vehicle according to claim 1,
wherein the regeneration process starts when the soot accumulation amount of one of the two exhaust particulate filters, which has a lower soot accumulation amount, exceeds a predetermined threshold value.

4. The method for regenerating the exhaust particulate filters in the V-type internal combustion engine for the vehicle according to claim 1,
wherein the regeneration process is terminated when the soot accumulation amount of one of the two exhaust particulate filters, which has a lower soot accumulation amount, decreases to a predetermined lower limit soot amount, which is set to ensure collection efficiency, by the regeneration process.

5. The method for regenerating the exhaust particulate filters in the V-type internal combustion engine for the vehicle according to claim 1,
wherein the regeneration process starts when the soot accumulation amount of one of the two exhaust particulate filters, which has a higher soot accumulation amount, exceeds a predetermined threshold value, and
wherein the regeneration process is terminated when the soot accumulation amount of one of the two exhaust particulate filters, which has a lower soot accumulation amount, decreases to a predetermined lower limit soot amount, which is set to ensure collection efficiency, by the regeneration process.

6. A device for regenerating exhaust particulate filters in a V-type internal combustion engine for a vehicle, wherein the V-type internal combustion engine is a spark-ignition-type engine, has a pair of banks and the exhaust particulate filters provided in respective exhaust passages of the pair of banks, and is connected with an automatic transmission, the device comprising:
a controller configured to perform regeneration process for the exhaust particulate filters of the respective banks,
wherein the controller is configured to:
estimate a soot accumulation amount in each of the exhaust particulate filters of a corresponding one of the banks; and
simultaneously start the regeneration process for the exhaust particulate filters of both the banks based on the soot accumulation amount of at least one of the exhaust particulate filters of the banks, and
wherein the regeneration process is performed by retarding ignition timing of both the banks and increasing an engine rotational speed of the internal combustion engine by changing a transmission ratio of the automatic transmission.
